(19) United States
(12) Patent Application Publication
(10) Pub. No.: US 2002/0015095 A1
(43) Pub. Date: Feb. 7, 2002

(54) HDTV portable viewing system

(76) Inventor: Edward L. Schilowitz, Los Angeles, CA (US)

Correspondence Address: WILLIAM COLLARD, COLLARD & ROE, P.C., 1077 NORTHERN BOULEVARD, ROSLYN, NY, 11576, US

(21) Appl. No.: 09/916,965

(22) Filed: Jul. 27, 2001

Related U.S. Application Data
(60) Provisional application No. 60/221,310, filed on Jul. 28, 2000.

(51) Int. Cl. H04N 7/18

(52) U.S. Cl. 348/158

(57) ABSTRACT

A system for viewing the output of an HDTV camera during filming containing a TFT/LCD flat screen monitor coupled to a HDTV to RGB converter. The monitor and converter are assembled in a portable carrying case that can be easily set up for viewing in the field. The system is connected to the HDTV camera and the camera's output can be viewed while filming in HDTV format. This way, the producer can view the output exactly how it will appear when broadcast in HDTV.

### CROSS-REFERENCE TO RELATED APPLICATIONS

This application claims the benefit of the filing date of copending Provisional Application Serial No. 60/221,310 filed Jul. 28, 2000.

### BACKGROUND OF THE INVENTION

1. Field of the Invention

This invention relates to a system for viewing the output of a HDTV camera during filming. In particular, the invention relates to a system in which the output from the HDTV camera is viewed as a digital image on a TFT/LCD flat screen at the same time as filming, thus giving the producers an accurate idea of the broadcast picture during filming.

2. The Prior Art

HDTV, or high definition television, is television that is broadcast via a digital signal. This requires that the filming be done with an HDTV camera, and the output of the camera is broadcast via digital signals. One of the problems with the current technology is that out in the field during filming, there is no simple and inexpensive way to view the HDTV camera output. The current models are based on CRT technology, making them heavy and cumbersome and making the screen too small to be truly functional.

### SUMMARY OF THE INVENTION

It is therefore an object of the invention to provide a way to view the HDTV camera's output during filming in HDTV format.

It is another object of the invention to provide a device for viewing the HDTV camera's output on a portable monitor.

These and other objects of the invention are accomplished by a system for viewing the output of an HDTV camera during filming comprising a TFT/LCD flat screen monitor coupled to a HDTV to RGB (red-green-blue) converter. The monitor and converter are assembled in a portable carrying case that can be easily set up for viewing in the field. The system is connected to the HDTV camera and the camera's output can be viewed while filming in HDTV format. This way, the producer can view the output exactly how it will appear when broadcast in HDTV.

The monitor is an active matrix TFT flat panel color display, which is capable of XGA or higher (SXGA or UXGA) resolution. The screen size is preferably between 7″ and 17″ diagonal. The monitor is connected to the converter via high resolution cable(s) (1x-BNC HD-SDI 292 connection or 3x-BNC Y, Pb, Pr connections). The converter is connected to the HDTV camera via high resolution cable(s) as well. The converter is preferably the CVC 200 converter and/or the CVC HDSDI-ACR 100 converter manufactured by Extron Electronics. A description of this converter can be found on the internet at http://www.extron.com, the disclosure of which is herein incorporated by reference.

This converter converts the signals from the HDTV camera to RGBS or RGBHV signals, which can be shown on the flat screen monitor. The converter is small and weighs only about 2 lbs. The inputs and outputs are on BNC connectors. It has a power of 100 VAC to 240 VAC, 50/60 Hz, 12 Watts.

The system is enclosed in a carrying case so that it may be transported to filming locations. In one embodiment, the case is similar to a briefcase, with the monitor on one half and the converter in the other half. When opened, the monitor screen is positioned vertically and the converter is horizontal on the support surface.

In another embodiment, the converter is mounted to the back of the screen in one integral flat unit. There is a flat cover that covers the front of the monitor screen during transport. When the monitor is to be used, the cover is folded around and under the screen via hinges. The cover then acts as a stand for the monitor, which is now in position for viewing.

The system according to the invention is very portable and simple to operate. It eliminates the need to transport expensive, heavy equipment to the field location and enables viewing of the camera output in true HDTV resolution.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of a first embodiment of the system according to the invention;

FIG. 2 shows a perspective view of the embodiment shown in FIG. 1;

FIG. 3 shows a rear view of the embodiment shown in FIG. 1;

FIG. 4 shows a rear perspective view of the embodiment shown in FIG. 1;

FIG. 5 shows a block diagram of the components in the system according to the invention; and

FIG. 6 shows an alternative embodiment of the system according to the invention; and

FIG. 7 shows the converter for use in the system according to the invention.

### DETAILED DESCRIPTION OF THE PREFERRED EMBODIMENT

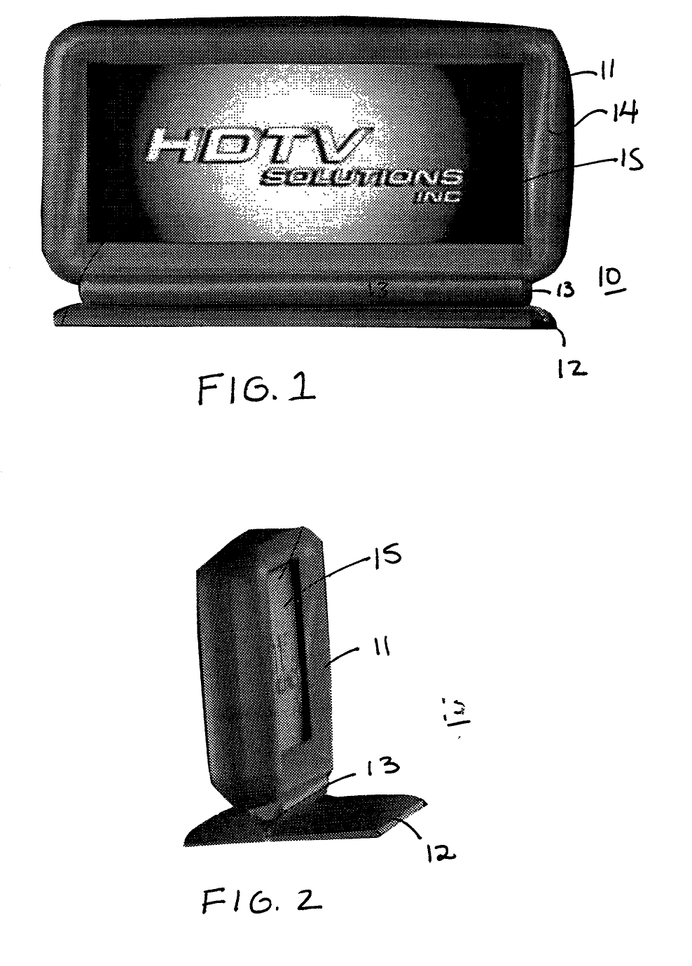

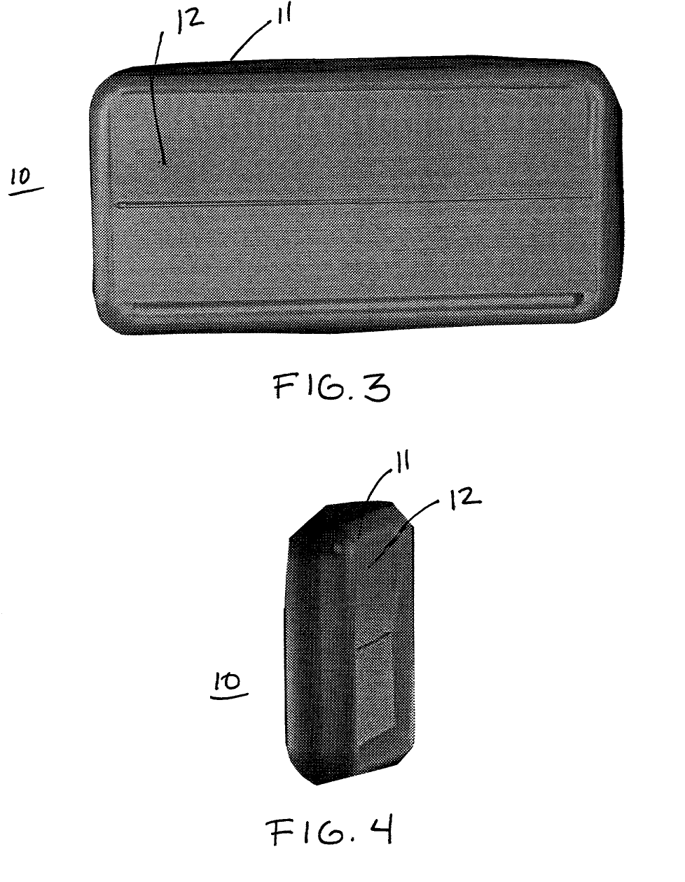

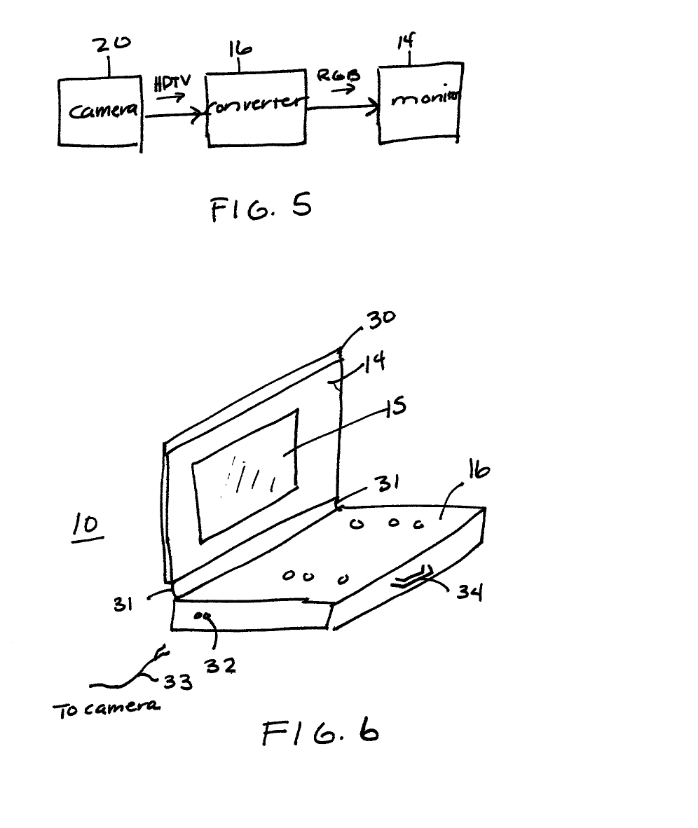

Referring now in detail to the drawings and, in particular, FIGS. 1-4 show one embodiment of the system 10 according to the invention. System 10 comprises an external housing 11 connected to a cover 12 via a hinge 13. Underneath cover 12 is a monitor 14 having a screen 15. Behind monitor 14 is an HDTV to RGB converter 16 (shown in FIG. 7). Converter 16 is connected to monitor 14. There are input ports located in housing 11 to connect converter 16 to an HDTV camera (not shown). During transportation, cover 12 covers screen 15 as shown in FIGS. 3 and 4. In use, cover 12 is rotated around to form a stand for converter 16 and monitor 14, as shown in FIGS. 1 and 2. A handle can be attached to housing 11 for ease of transportation.

A block diagram of the components of the system 10 is shown in FIG. 5. A HDTV camera 20 is connected via cables to converter 16, which is connected to monitor 14. The HDTV signals from camera 20 are converted to RGB signals by converter 16. Monitor 14 then displays the output of camera 29 in a digital format, which is identical to how the picture would appear when broadcast in HDTV. This greatly facilitates editing and filming, because the producers can see exactly how a picture would appear while it is being filmed.

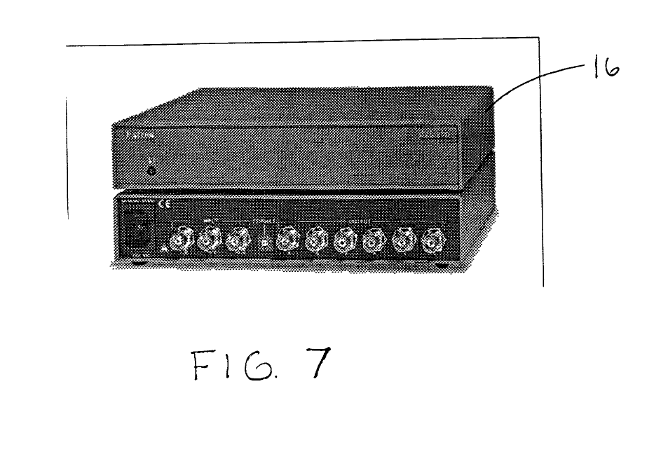

FIG. 6 shows another embodiment of the system 10 according to the invention. In this case, housing 30 comprises a briefcase-like structure, where monitor 14 is disposed in one half and converter 16 is disposed in the other half. The two halves are separated by hinges 31. A connection port 32 receives a cable 33 that connects monitor 16 to a HDTV camera (not shown). A handle 34 is attached to housing 30 to facilitate transporting system 10 to and from the field.

Accordingly, while only a few embodiments of the present invention have been shown and described, it is obvious that many changes and modifications may be made thereunto without departing from the spirit and scope of the invention.

What is claimed is:

1. A portable viewing system for attaching to an HDTV camera, comprising:
an external housing having input ports for connecting the HDTV camera;
a flat screen monitor having a front and back side disposed within the housing, the monitor comprising a screen on said front side for viewing; and
a converter attached to the back side of the monitor for converting HDTV signals to RGB signals.

2. The viewing system according to claim 1, further comprising a cover for protecting the monitor when not in use.

3. The viewing system according to claim 2, wherein the cover is attached to the external housing via hinges such that the cover can rotate around forming a stand.

4. The viewing system according to claim 1, wherein the external housing comprises a brief-case structure having a first and a second half.

5. The viewing system according to claim 4, wherein the monitor is disposed in said first half fo the external housing.

6. The viewing system according to claim 5, wherein the converter is disposed in said second half of the external housing.

7. The viewing system according to claim 4, wherein said first half is connected to said second half via hinges.

8. The viewing system according to claim 4, further comprising a handle on the external housing for facilitating transportation.
